(19) United States
(12) Patent Application Publication
(10) Pub. No.: US 2025/0059356 A1
(43) Pub. Date: Feb. 20, 2025

(54) WAX-CELLULOSE NANOCOMPOSITE PACKAGING MATERIAL

(71) Applicant: Abu Dhabi University, Abu Dhabi (AE)

(72) Inventor: Chandra Mouli Madhuranthakam Radhakrishna, Abu Dhabi (AE)

(73) Assignee: Abu Dhabi University, Abu Dhabi (AE)

(21) Appl. No.: 18/518,865

(22) Filed: Nov. 24, 2023

Related U.S. Application Data
(60) Provisional application No. 63/533,636, filed on Aug. 19, 2023.

(51) Int. Cl. C08L 1/02; C08K 5/053

(52) U.S. Cl. CPC C08L 1/02; C08K 5/053

(57) ABSTRACT

A wax-cellulose nanocomposite material includes equilibrated amorphous cellulose. The equilibrated amorphous cellulose has a density of 1.3733 g/cm3. The wax-cellulose nanocomposite material includes nonacosane-10-ol. The wax-cellulose nanocomposite material includes nonacosane-5,10-diol. The wax-cellulose nanocomposite material includes adulose.

### BACKGROUND

Packaging materials are predominantly selected based on permeability to gases, water vapor, oil, grease, heat, light, and microorganisms which can directly or indirectly affect the product quality and shelf life. Different polymer materials, either synthetic or natural, have been engineered to confer antimicrobial features. Packaging material made of biopolymers is gaining more importance to overcome the problem of disposability and degradability of synthetic polymer-based packaging material. With food packaging materials, consumers always prefer and demand the use of natural biomaterials compared to synthetic materials. There is a huge gap in the differences between the properties of synthetic polymer materials and natural biomaterials.

There is presently no ecofriendly cellulose-wax composite that is currently in use for food packaging materials.

### BRIEF DESCRIPTION OF DRAWINGS

FIG. 1 is a diagram of an example graph;

FIG. 2 is a diagram of an example graph;

FIG. 3 is a diagram of an example graph

FIG. 4 is a diagram of an example graph;

FIG. 5 is a diagram of an example graph;

FIG. 6 is a diagram of an example graph;

FIG. 7 is a diagram of an example graph;

FIG. 8 is a diagram of an example graph;

FIG. 9 is a diagram of an example table;

FIG. 10 is a diagram of an example graph;

FIG. 11 is a diagram of an example graph;

FIGS. 12A, 12B, and 12C are diagrams of example graphs;

FIG. 13 is a diagram of an example graph;

FIG. 14 is a diagram of an example table;

FIG. 15 is a diagram of an example graph;

FIGS. 16A and 16B are diagrams of example graphs;

FIG. 17 is a diagram of an example network; and

FIG. 18 is a diagram of an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may involve the analysis of mechanical properties, thermal stability, and diffusion of certain species in adulose using molecular dynamics simulations (MDS). In embodiments, MDS is an effective tool for predicting and estimating the barrier properties, mechanical and thermal behavior of materials.

In embodiments, using the results obtained from MDS, mechanical properties are studied by conducting stress strain simulations while thermal stability is studied by estimating and evaluating the glass transition temperature (Tg). In embodiments, the diffusion of oxygen, nitrogen, and water molecules in adulose is analyzed by calculating the diffusion coefficient and fraction free volume (FFV) which are important barrier property attributes. Accordingly, a wax-cellulose nanocomposite material is determined with particular characteristics such that the nanocomposite material is an ecological friendly packing material.

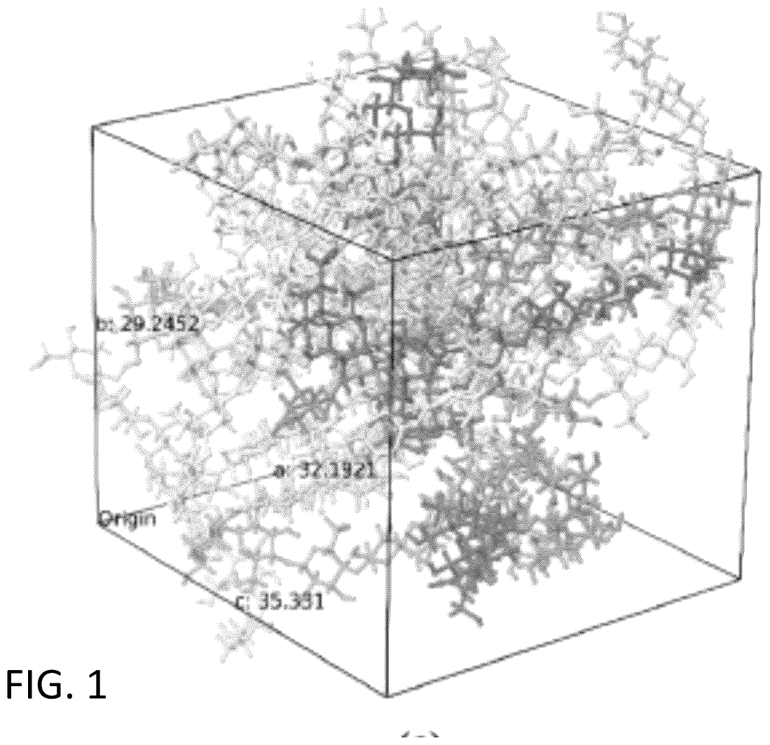

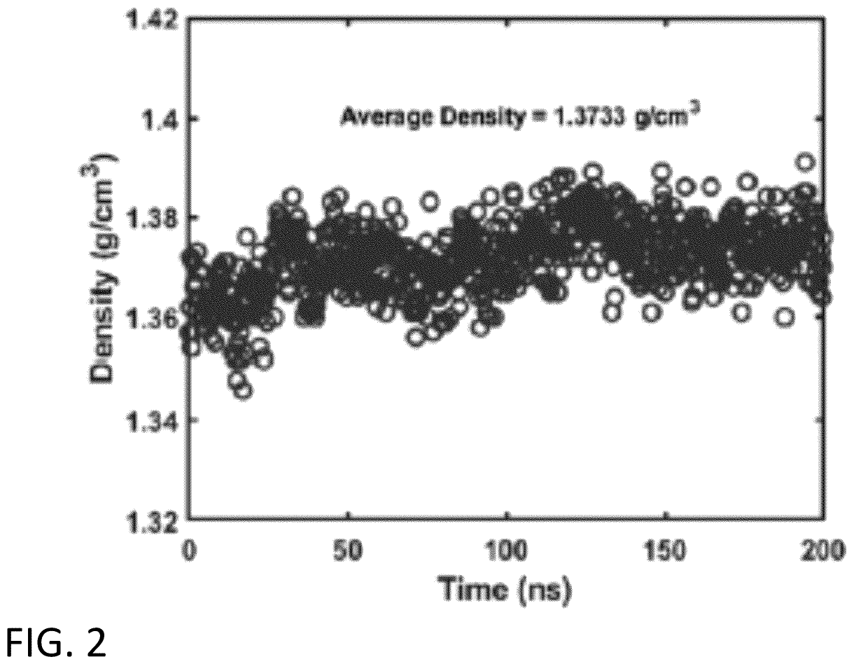

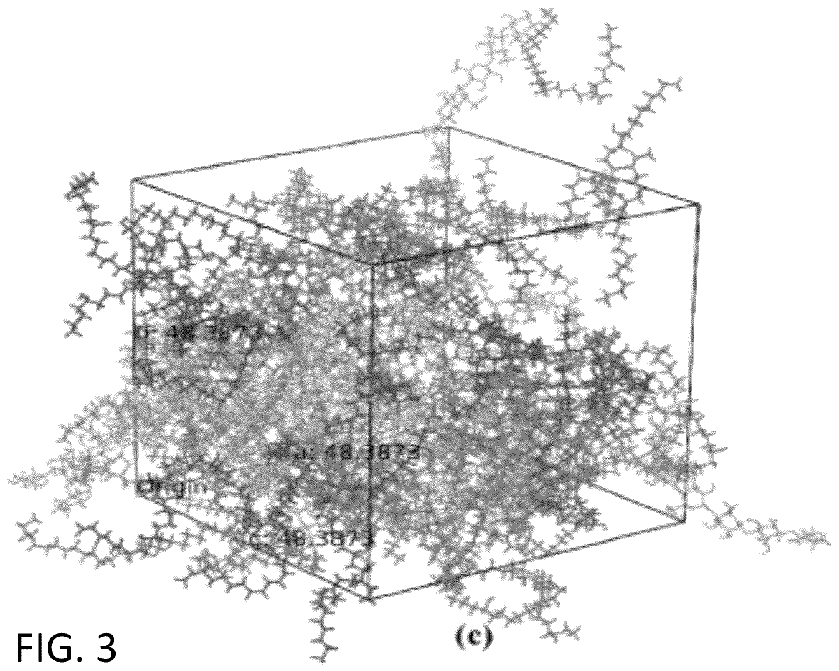

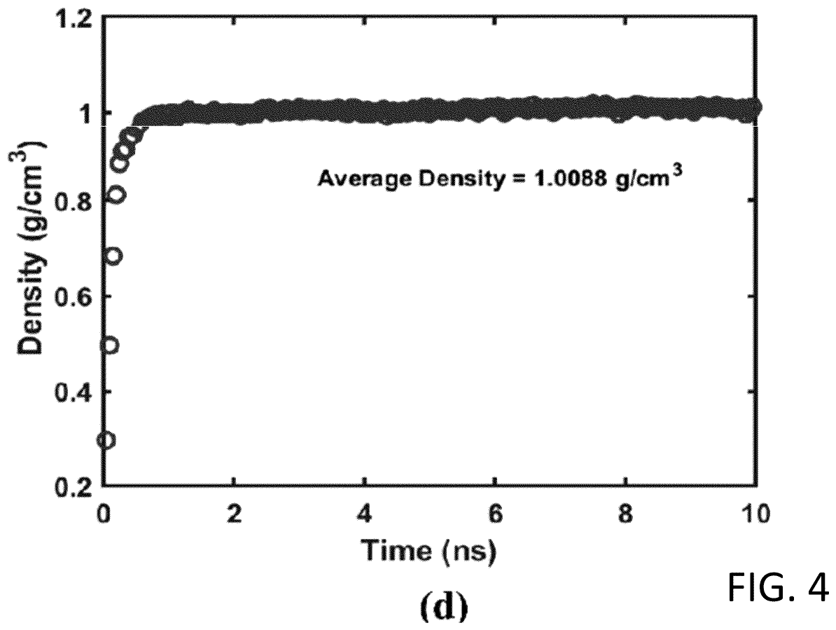

In embodiments, a system with cellulose chains is relaxed and equilibrated for 200 ns while the systems with the two different types of wax are relaxed and equilibrated for 10 ns. Cellulose has longer chain length compared to the wax molecules due to which MDS for cellulose is performed for longer simulation time. In embodiments, a value for equilibration time is also decided based on the constant density/volume profiles obtained in these simulations. FIG. 1 is an example graph describing the relaxed and equilibrated amorphous cellulose system while FIG. 2 is an example graph that describes the density profile with respect to equilibration time. FIGS. 3 and 4 describe the equilibrated adulose system and density profiles, respectively.

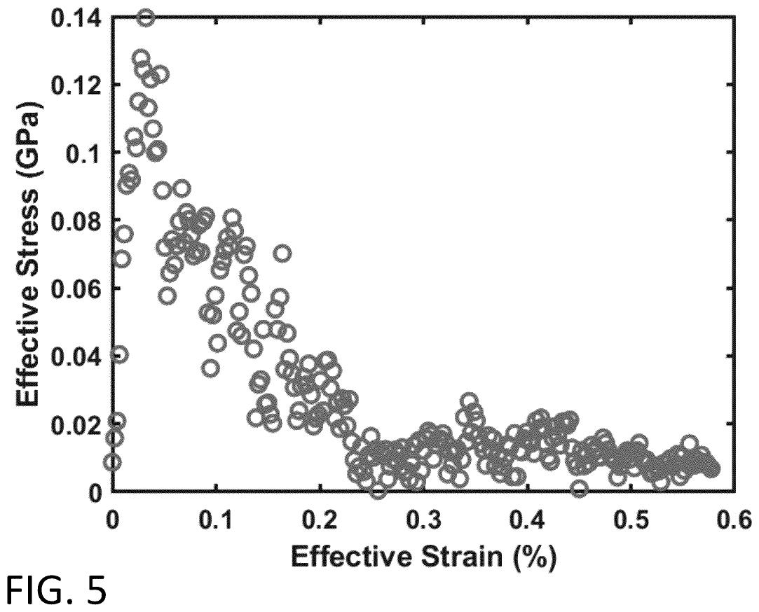

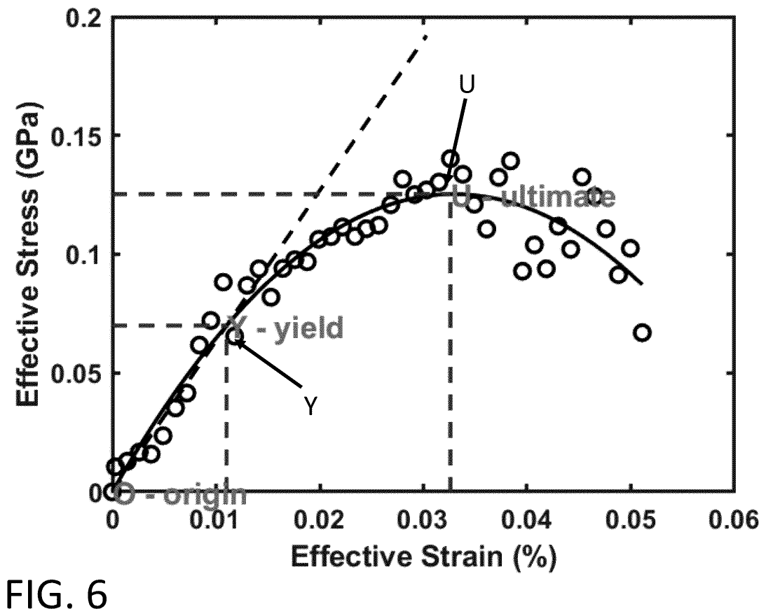

In embodiments, the density of the equilibrated amorphous cellulose is determined to be 1.3733 g/cm³. In embodiments, nonacosane-10-ol and nonacosane-5,10-diol are derivatives of nonacosane which has a density of 0.808 g/cm³. In embodiments, the density of nonacosane-10-ol is 0.840 g/cm3 and the density of adulose is determined to be 1.008 g/cm3 from the MDS. In embodiments, both nonacosane-10-ol and nonacosane-5,10 diol are plant-derived waxes that have least mechanical strength but offers advantages with respect to achieving enhanced properties when used as a filler in cellulose and polyethylene-based composites. In embodiments, a small addition of oxidized Fisher-Tropsh wax (which is a synthetic chemical) can improve the mechanical properties of polyethylene. FIGS. 5 and 6 are example graphs that describe the results obtained from the stress strain simulations for cellulose.

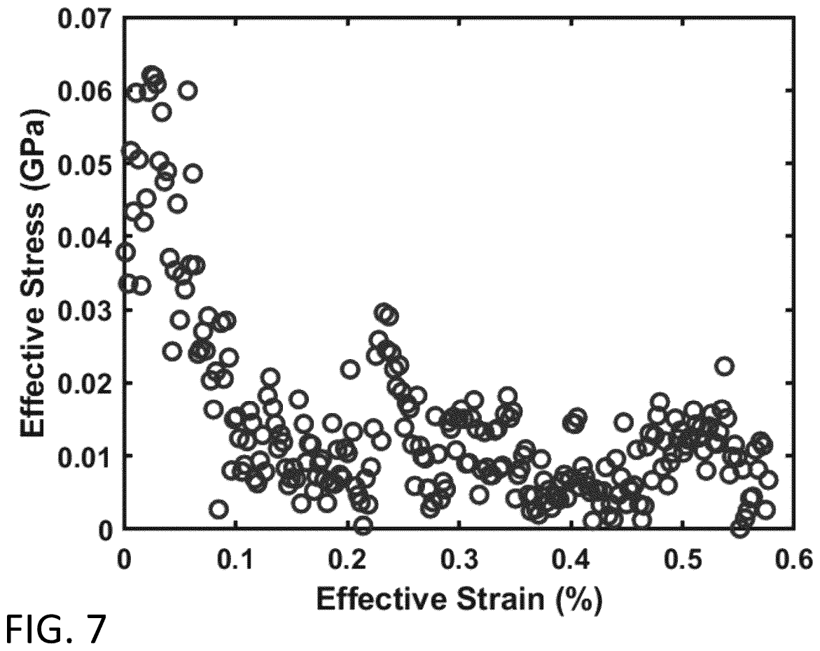

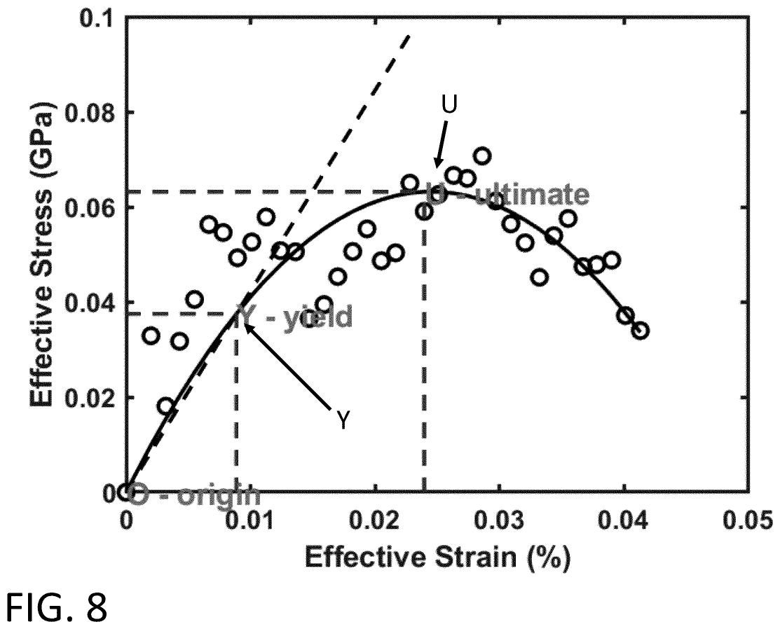

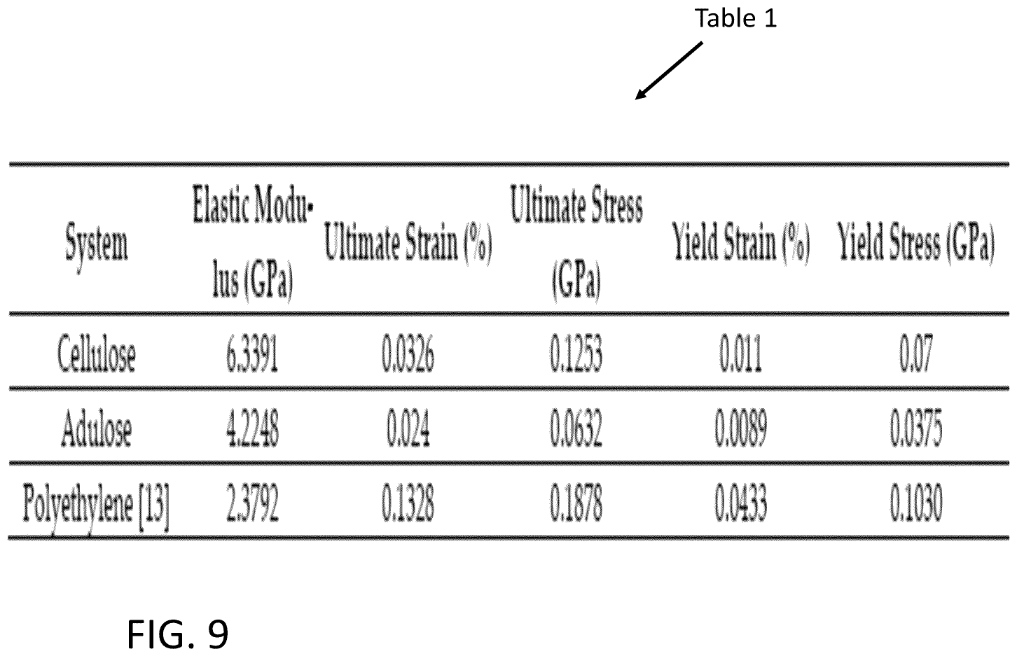

FIGS. 7 and 8 are example graphs that describe the corresponding results obtained for adulose. In embodiments, by using a nonlinear least squares MATLAB program, a second order polynomial (with zero intercept) is fit to the stress-strain data obtained from the molecular simulations. In embodiments, the ultimate stress and ultimate strain are obtained from the corresponding maximum values for the fitted polynomial (corresponding to the maximum point “U” on the curves described in FIGS. 6 and 8). In embodiments, the yield stress and yield strain that constitutes the elastic limit represented by the point Y as shown in FIGS. 6 and 8 is found by fitting a straight line (with zero intercept passing through the origin “O”) to the portion of the second order polynomial beyond which the slope does not change. In embodiments, the Young's modulus of the material is obtained from the slope of this fitted line. In embodiments, the procedure can be easily understood by referring to the stress-strain curves obtained for cellulose and adulose as shown in FIGS. 6 and 8 respectively. In embodiments, the summary of the mechanical properties for cellulose and adulose corresponding to the FIGS. 6 and 8 is shown in FIG. 9 (describing Table 1).

As shown in FIG. 9, Table 1 describes the elastic modulus, ultimate stress, and yield stress of adulose which is shown to be less than those of cellulose. Similarly, the yield strain and ultimate strain of adulose are also comparatively less than that of cellulose. In embodiments, the packing material described herein has tangled chains and amorphous cellulose. In embodiments, the material described herein is a nano-composite of mixed cellulose chains and the waxes which is in contrast to layer by layer of two waxes around cellulose chains.

Since the elastic modulus of adulose is observed to be greater than that of polyethylene or polyethylene wax composite, thus making adulose to be a good choice when used as a packaging material with less flexibility. At the same time, adulose is more elastic than cellulose that makes using adulose in at least some of the packaging materials in lieu of the synthetic non-biodegradable plastic packaging materials. In embodiments, adulose derives maximum mechanical strength from the cellulose chains, and it is observed that other desirable properties for adulose are obtained as will be further described herein.

While the strength of the materials considered in this study is assessed by analyzing its mechanical properties, the stability of these materials is further investigated by conducting thermophysical simulations. In embodiments, glass transition temperature (Tg) is calculated such simulation results. In embodiments, Tg values of cellulose and adulose are obtained by using a piece-wise bilinear fit to the temperature versus specific volume data obtained from the thermophysical simulations.

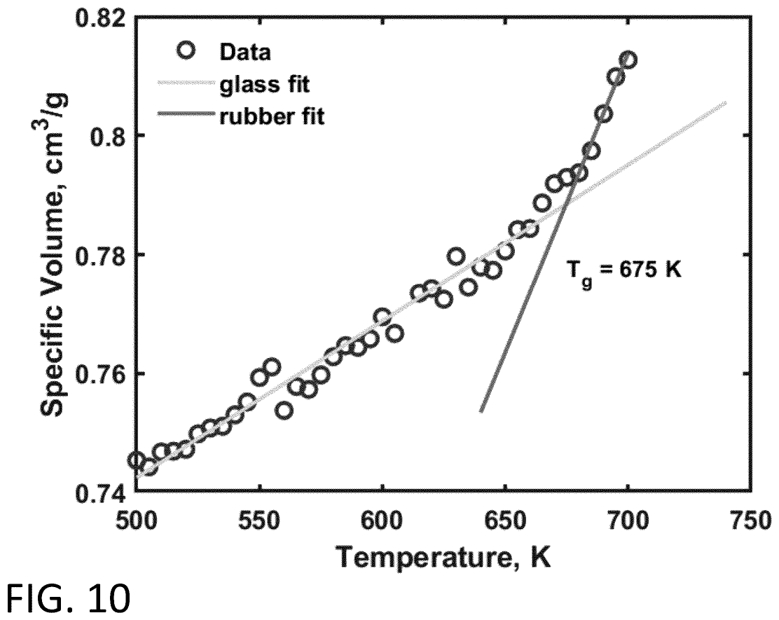

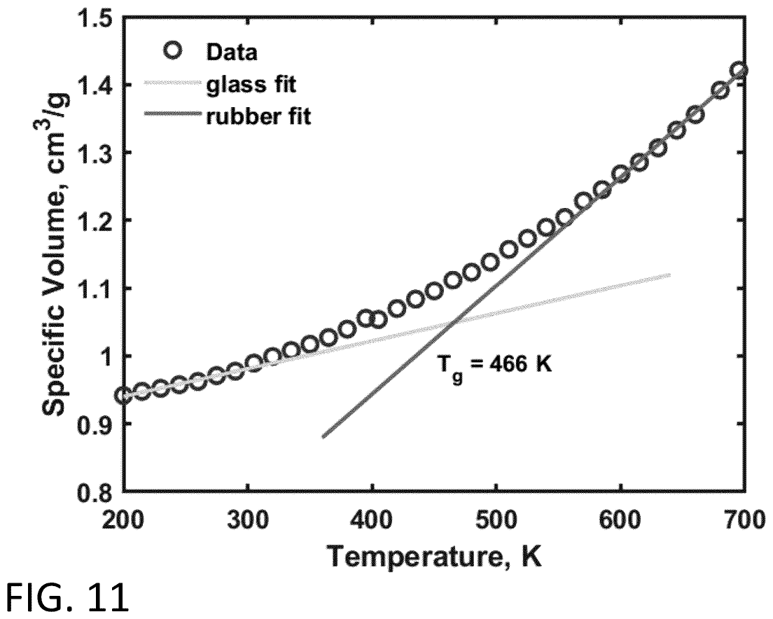

FIGS. 10 and 11 are example graphs that describe the profiles for the temperature versus specific volume obtained from the thermophysical simulations for cellulose and adulose respectively. FIG. 10 describes an example graph that the Tg of cellulose is 675 K while Tg of adulose is obtained as 466 K. Cellulose exhibits different transitions based on its crystallinity and amount of water associated with it. Within cellulose, there are α-cellulose, β-cellulose, and amorphous cellulose types with each of them having a different range of Tg values. In embodiments, the Tg of amorphous cellulose is 448 K or 493 K from experiments where cellulose powder was used. In embodiments, the Tg of amorphous cellulose is 650 K with an addition of 40 K due to the time scale at which experimental measurements were made. In embodiments, a 200 ps dynamics corresponds to approximately frequencies in the order of 1 MHz.

In embodiments, glass transition temperature is an important thermophysical property which is attributed to the flexibility of a polymer due to the movement of the backbone chains which in turn occurs due to rotational and translational motion. Thus, this movement of the backbone chains leads to the generation of free volume or unoccupied space with an opposite effect-higher free volume leads to lower Tg values and vice versa. In embodiments, for the cellulose, a high value of Tg is observed. In embodiments, the free volume of cellulose is obtained by using a molecular probe with certain radius RP that moves on the van der Waals surface. In embodiments, the fraction free volume, FFV is defined according to equation (1) as shown below:

$$F F V = \frac{{V}_{F}}{{V}_{F} + {V}_{O}}$$

As shown in equation (1), V_{F} is the free volume of the polymer, V_{O} is the volume occupied by the polymer and the sum of V_{F} and V_{O} is the total volume of the polymer. In embodiments, the free volume estimation is also helpful in understanding the diffusion characteristics of different species in cellulose/adulose. In embodiments, with a probe radius of 0.1 Å, the FFV for cellulose is obtained to be 28.24%, while for adulose it is 75.47%. In embodiments, the low value of Tg for adulose can be understood from the perspective of FFV values obtained from MDS. By adding nonacosane-10-ol and nonacosane-5,10 diol to the cellulose, with a portion of these molecules occupying the free space in cellulose, it is observed that there is a huge increase in the volume. In embodiments, the volume of cellulose is 32,977 Å³ while volume of adulose is 113,310 Å³. From the thermophysical results, with the Tg of adulose being far less than that of cellulose, adulose can be used as packaging material for a wide range of applications. In embodiments, the barrier properties of adulose are assessed by studying the diffusion of oxygen, nitrogen, and water using MD simulations. In embodiments, oxygen, nitrogen, and carbon dioxide are used in modified atmosphere packaging. In embodiment, the diffusion rates of these species determine the type of application in which adulose can be used as a packaging material.

The requirement of high or low diffusion rates of these species strongly depends on the characteristics of the material stored and also its intended shelf life or end-use applications. For example, if the packaging material is used for storing fresh food, then a low diffusion or permeability rate of oxygen is desired as it can reduce the oxygen pressure inside due to which the shelf life of the product increases. In embodiments, with respect to the number of water molecules used, the SPC/E model gives reliable diffusion rates very close to the experimentally observed values independent of the number of water molecules used in the simulation.

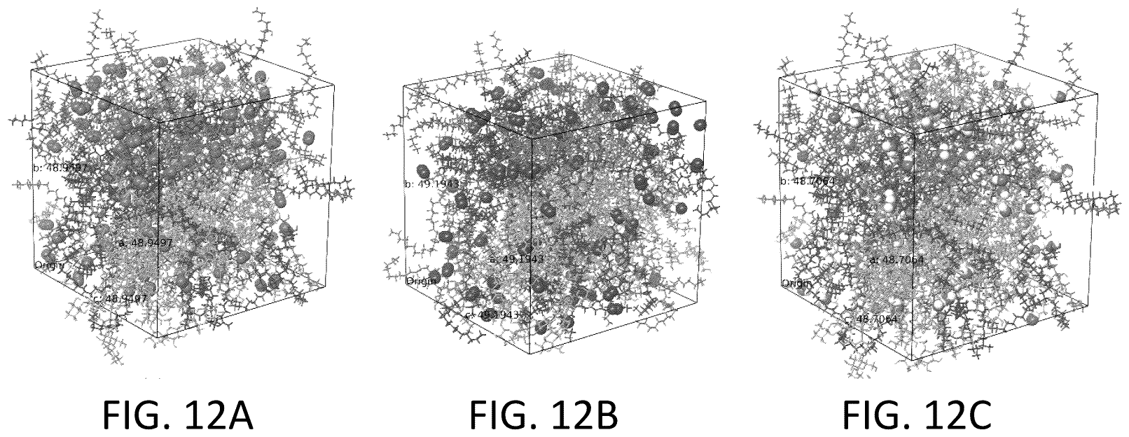

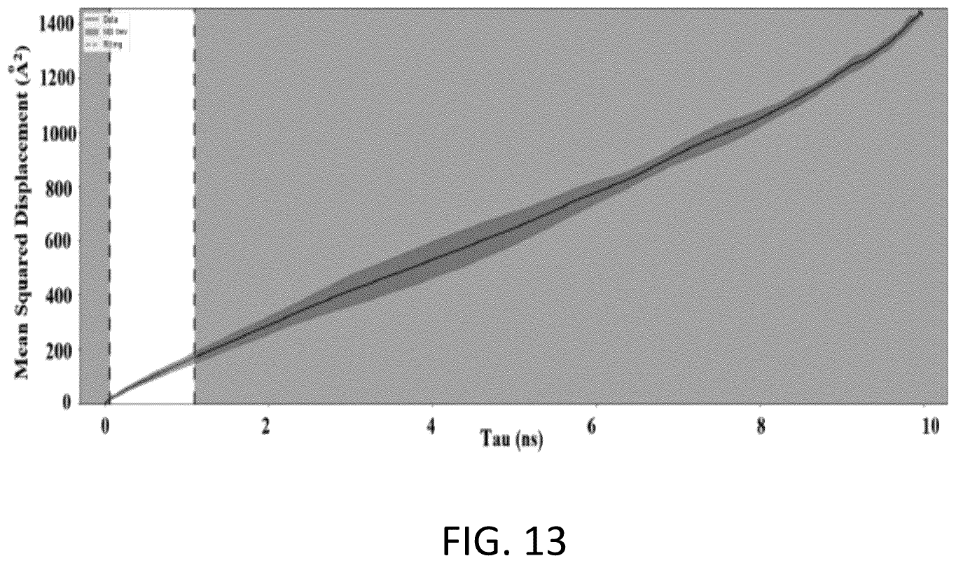

In embodiments, 100 molecules of oxygen, nitrogen, and water are used to estimate the diffusion coefficient in cellulose and adulose. In embodiments, the MSD of the corresponding molecules are obtained from which the diffusion coefficient is estimated. Also, a more accurate estimation is obtained using the linear portion of the MSD. FIGS. 12A, 12B, and 12C describe adulose with oxygen, nitrogen, and water molecules respectively. In FIGS. 12A, 12B, and 12C, tau (t) is the simulation time difference and the linear portion of the MSD corresponds to tau values in the range of 0 to 0.99 ns. FIG. 13 shows the MSD obtained for adulose with oxygen system (similar curves are obtained for adulose with nitrogen and water systems).

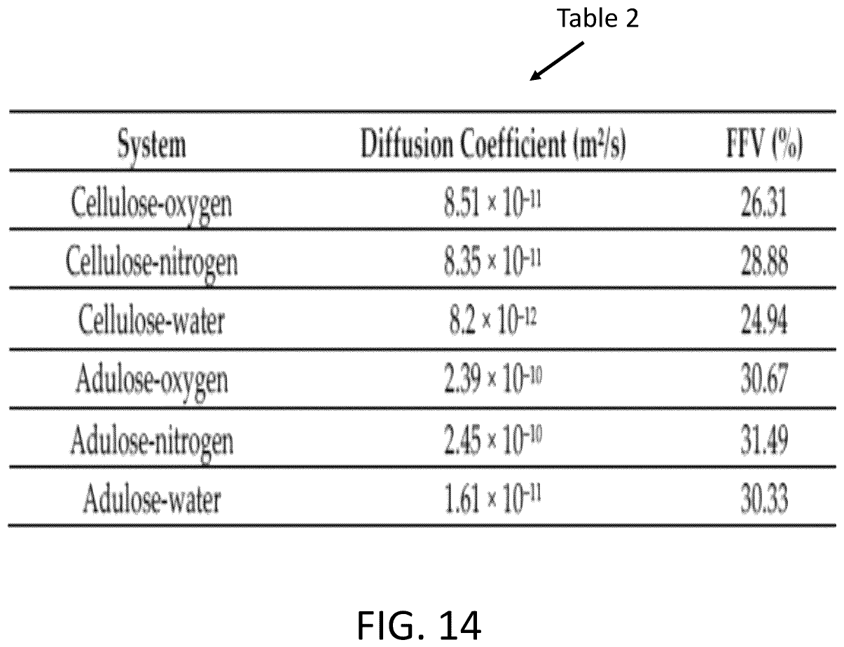

In embodiments, the diffusion coefficients at 300 K and 1.01325 bar obtained from the MDS are shown in Table 2, in FIG. 14, along with the FFV percentages (calculated according to equation (2)) using a probe radius of 0.1 Å. Table 2 as shown in FIG. 14, describes diffusion coefficients and FFV for oxygen, nitrogen, and water in cellulose and adulose.

In embodiments, the experimental diffusion coefficients of oxygen, nitrogen, and water in cellulose depends on several factors such as solubility, permeability, pressure, temperature, and source from which cellulose is extracted. In embodiments, the diffusion coefficients obtained for oxygen, nitrogen, and water in adulose systems are greater than those obtained for cellulose systems. This can be understood from the FFV values estimated from MDS and shown in Table 2 (in FIG. 14). The atomic radius of oxygen and nitrogen are 60 and 65 pm due to which the FFV values obtained for them in both cellulose and adulose are almost same which in turn resulted in obtaining similar diffusion coefficient values.

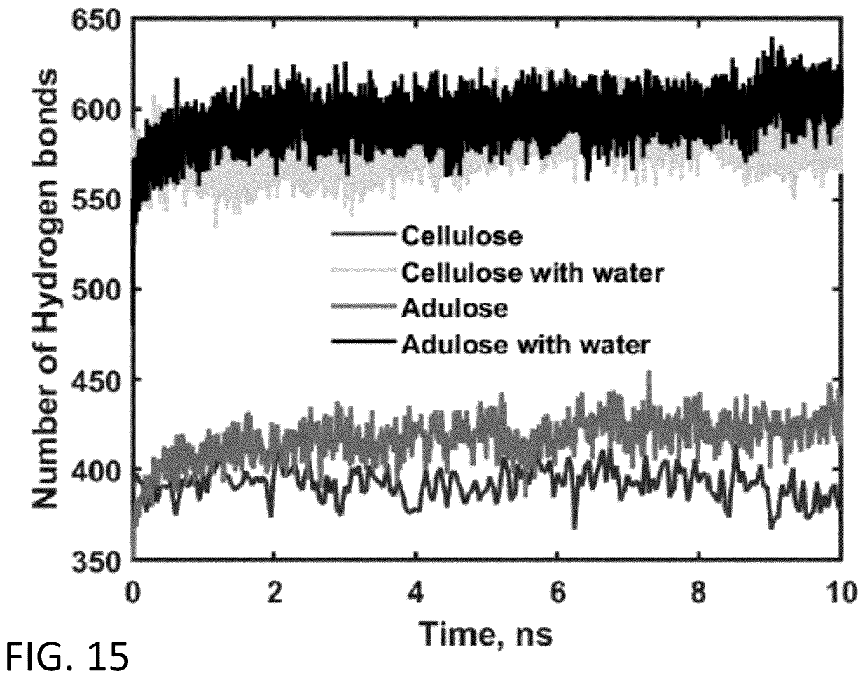

In embodiments, the diffusion coefficient of oxygen in adulose is 2.39×10−10 m2/s which is 50% less than that of diffusion coefficient of oxygen in polyethylene (5.062×10−10 m2/s) [20]. In embodiments, this makes adulose to be a competing candidate for the packaging material with enhanced barrier properties compared to that of polyethylene-based packaging material. In embodiments, the FFV for water is observed to be less than that of oxygen or nitrogen in cellulose/adulose due to an increase in the hydrogen bonds formed by water molecules with cellulose. In embodiments, a hydrogen bond is defined as the attraction of a covalently bonded hydrogen atom with another electronegative atom. In embodiments, a hydrogen bond is defined geometrically as having a hydrogen-acceptor distance of less than 2.8 Å, minimum donor angle to be 120° and minimum acceptor angle to be 90°. The number of hydrogen bonds directly or indirectly affect not only the mechanical properties but also the anti-aging performance. FIG. 15 is an example graph that describes the profiles for hydrogen bonds obtained for cellulose, cellulose with water, adulose, and adulose with water systems.

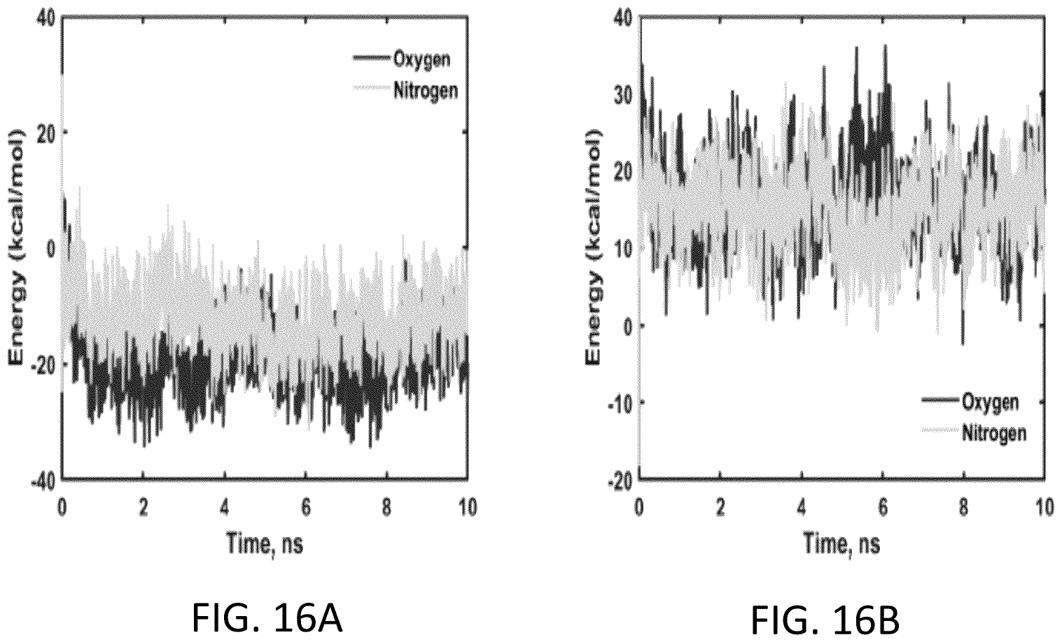

The statistical average of the number of hydrogen bonds for cellulose, cellulose with water, adulose, and adulose with water systems is found to be 392, 581, 417, and 595 respectively. Further the higher diffusion coefficients of oxygen and nitrogen in cellulose can be understood by estimating the interaction energy. Interaction energy (Eint) indicates the intensity of the interaction between the diffusion molecule and the main chains (cellulose or wax molecules). Interaction energy is calculated by using equation (2) as shown below:

$${E}_{int} = {E}_{total} - {E}_{cellulose} - {E}_{wax} - {E}_{i}$$

where Etotal is the total energy of the system, Ecellulose_{c} is the energy of the cellulose chains, Ewax is the energy of the nonacosane-10-ol and nonacosane-5,10 diol and Ei is the energy of the diffusing species i (oxygen or nitrogen or water in this case). Any species “i” will have stronger interaction if the corresponding Eint value is very high with a negative magnitude. A higher energy barrier requires overcoming molecules with high Eint values which in turn also means that their corresponding diffusion coefficients will be low. FIGS. 16A and 16B describe the energy profiles obtained for oxygen and nitrogen in cellulose and adulose.

As shown in the graphs described in FIGS. 16A and 16B, oxygen and nitrogen have high negative interaction energies in cellulose compared to that of adulose. Thus, oxygen and nitrogen have strong interaction to cellulose chains compared to adulose which also explains the higher diffusion coefficient observed in adulose compared to that of cellulose.

In embodiments, the cellulose chains (the repeating unit for cellulose homopolymer is beta-D-glucose and 12-mers are used in this simulation), non-acosan-10-ol, nonacosan-5,10 diol, oxygen, nitrogen and water molecules chemical structures were drawn using the 2D sketcher which were further converted to 3D using the MS Maestro interface. In embodiments, adulose with 95% cellulose, 3% nonacosan-10-ol, and 2% nonacosan-5,10-diol (all weight percent) was built using the Disordered System builder in the MS Suite. A unit cell with 5 nm×5 nm×5 nm was used. In embodiments, twenty-four chains of cellulose each consisting of 149 atoms were embedded with 48 molecules of each of the waxes (nonacosan-10-ol and nonacosan-5,10 diol). Using the Multi-Stage Simulation workflow in MS suite, all the structures were initially relaxed and equilibrated for 200 ns.

In embodiments, the relaxation and equilibration involved conducting MD simulation for 10 ns initially at 300 K and 1.01325 bar with NPT ensemble followed by Brownian minimization for 100 ps and finally MD simulation for 200 ns with NPT ensemble at 300 K and 1.01325 bar. The analysis of bulk properties for the final system is performed after equilibration. In embodiments, the stress strain calculations were performed using the option of pure uniaxial condition, with a strain rate of 1.0×10⁸ s⁻¹ and using a strain step size of 0.001 for 1000 steps. The stress-strain simulations were run for a maximum strain of 0.9. In embodiments, the corresponding results are used for estimating the Young' modulus, yield stress, yield strain, ultimate stress, and ultimate strain. In the simulation protocol, a simulation time of 10 ps with a time step of 2.0 fs is used and a trajectory recording interval of 5 ps is set at a temperature of 300 K.

In embodiments, the number of hydrogen bonds and the interactive energies for all scenarios are estimated and used to understand the behavior of the cellulose nanocomposite. In embodiments, simulations related to thermophysical properties for evaluating glass transition temperature were conducted by cooling the cellulose and adulose systems from 700 K to 200 K in steps of 5 K constrained to con-vergence from each previous step. These simulations were performed for 10 ns at a pressure of 1.01325 bar, for three maximum cycles and corresponding to a 5% convergence. A trajectory of temperature versus specific volume is obtained from all thermophysical property simulations.

Using a bilinear fit for the rubbery region and glassy region, the corresponding glass transition temperature is obtained for cellulose and adulose. In embodiments, barrier properties of the cellulose nanocomposite are studied and estimated by conducting diffusion simulations. The main diffusion species considered in this study are oxygen, nitrogen and water. A method of estimating the diffusion coefficient from the mean square displacement (MSD) curve is used. In embodiments, the diffusion coefficient (D) of a species is calculated as shown in equation (3) given below:

$$D = \frac{1}{6 N} {}_{t \to ∞} \frac{d}{dt} {\sum }_{i = 1}^{N} 〈 {[ {r}_{i} ( t ) - {r}_{i} ( 0 ) ]}^{2} 〉$$

where N is the number of molecules of that species, rᵢ(0) and rᵢ(t) are the initial position coordinate and position coordinate of particle i at any time, t respectively.

In embodiments, cellulose-based nanocomposite that consists of plant-derived waxes, nonacosane-10-ol and nonacosane-5,10-diol was simulated to assess its potential for using as packaging material. In embodiments, molecular dynamics simulations were conducted from which different properties of this material were obtained. Mechanical properties simulations show that adulose has Young's modulus of 4.2248 GPa which is greater than that of polyethylene while less than that of pure cellulose. Other mechanical properties such as the ultimate stress, ultimate strain, yield stress, and yield strain are obtained for adulose. From the thermo-physical property simulations, the glass transition temperature of adulose was found to be 466 K which is less than that of cellulose which is 675 K. Addition of very small amount of waxes to cellulose led to a significant decrease in the Tg values. Furthermore, the amount of wax added to cellulose may be manipulated and optimized for obtaining Tg values that are amenable to process adulose and use it as a substitute for polyethylene packaging material. In embodiments, barrier properties of adulose showed that it can be a potential candidate for using in packaging applications.

In embodiments, the diffusion coefficient of oxygen, nitrogen, and water molecules through adulose were obtained to be 2.39×10⁻¹⁰, 2.45×10⁻¹⁰, and 1.61×10⁻¹¹ m²/s respectively which are at least 50% less than that of corresponding diffusivities reported in polyethylene. Thus, adulose is an ecofriendly sustainable packaging material with good mechanical, thermal, and barrier properties.

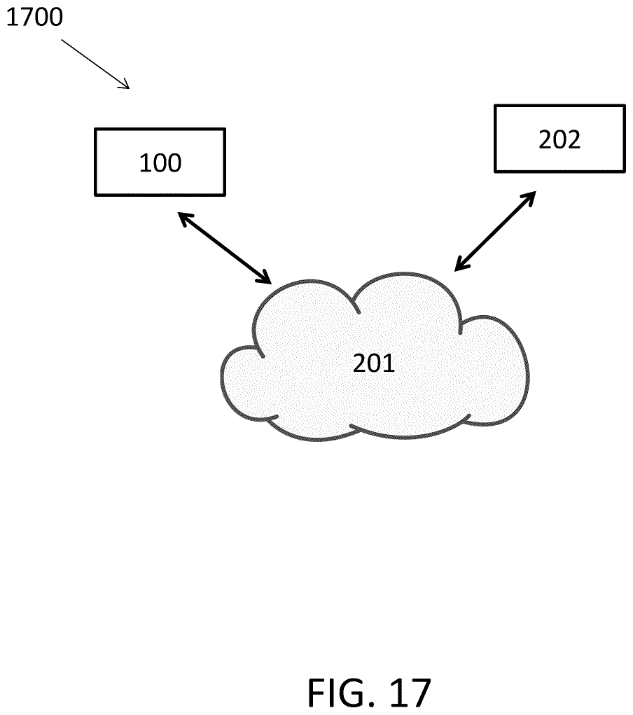

FIG. 17 is a diagram of example environment 1700 in which systems, devices, and/or methods described herein may be implemented. FIG. 2 shows network 201, apparatus 100, and database 202. Network 201 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks.

Additionally, or alternatively, network 201 may include a cellular network, a public land mobile network (PLMN), a second generation (2G) network, a third generation (3G) network, a fourth generation (4G) network, a fifth generation (5G) network, and/or another network. In embodiments, network 122 may allow for devices describe in any of the figures to electronically communicate (e.g., using emails, electronic signals, URL links, web links, electronic bits, fiber optic signals, wireless signals, wired signals, etc.) with each other so as to send and receive various types of electronic communications. In embodiments, network 201 may include a cloud network system that incorporates one or more cloud computing systems.

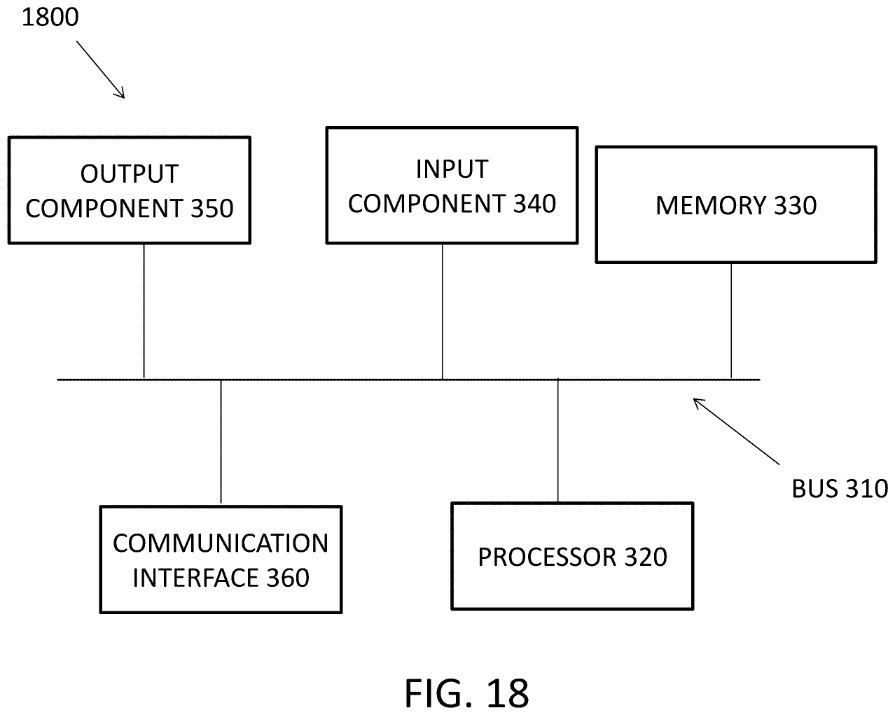

Apparatus 100 may include any computation or communications device that is capable of communicating with a network (e.g., network 201). Apparatus 100 may be a computing device (such as described in FIG. 18) that can generate the simulations, tables, and graphs described in the above figures.

Apparatus 100 may receive and/or display electronic content. In embodiments, the electronic content may include objects, data, images, audio, video, text, files, and/or links to files accessible via one or more networks. Content may include a media stream, which may refer to a stream of electronic content that includes video content (e.g., a video stream), audio content (e.g., an audio stream), and/or textual content (e.g., a textual stream). In embodiments, an electronic application may use an electronic graphical user interface to display content and/or information via apparatus 100. Apparatus 100 may have a touch screen and/or a keyboard that allows a user to electronically interact with an electronic application or a webpage (either containing electronic content). In embodiments, a user may swipe, press, or touch a portion of apparatus 100 in such a manner that one or more electronic actions will be initiated by apparatus 100 via an electronic application.

Database 202 may include any computation or communications device that store electronic information. In embodiments, database 202 may store electronic information about materials described above.

FIG. 18 is a diagram of example components of a device 1800. Device 1800 may correspond to network 201, apparatus 100, and/or database 202. Alternatively, or additionally, network 201, apparatus 100, and/or database 202 may include one or more devices 1800 and/or one or more components of device 1800.

As shown in FIG. 18, device 1800 may include a bus 310, a processor 320, a memory 330, an input component 340, an output component 350, and a communications interface 360. In other implementations, device 1800 may contain fewer components, additional components, different components, or differently arranged components than depicted in FIG. 18. Additionally, or alternatively, one or more components of device 1800 may perform one or more tasks described as being performed by one or more other components of device 1800.

Bus 310 may include a path that permits communications among the components of device 1800. Processor 320 may include one or more processors, microprocessors, or processing logic (e.g., a field programmable gate array (FPGA) or an application specific integrated circuit (ASIC)) that interprets and executes instructions. Memory 330 may include any type of dynamic storage device that stores information and instructions, for execution by processor 320, and/or any type of non-volatile storage device that stores information for use by processor 320. Input component 340 may include a mechanism that permits a user to input information to device 1800, such as a keyboard, a keypad, a button, a switch, voice command, etc. Output component 350 may include a mechanism that outputs information to the user, such as a display, a speaker, one or more light emitting diodes (LEDs), etc.

Communications interface 360 may include any transceiver-like mechanism that enables device 1800 to communicate with other devices and/or systems. For example, communications interface 360 may include an Ethernet interface, an optical interface, a coaxial interface, a wireless interface, or the like. In another implementation, communications interface 360 may include, for example, a transmitter that may convert baseband signals from processor 320 to radio frequency (RF) signals and/or a receiver that may convert RF signals to baseband signals. Alternatively, communications interface 360 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 360 may connect to an antenna assembly (not shown in FIG. 3) for transmission and/or reception of the RF signals. The antenna assembly may include one or more antennas to transmit and/or receive RF signals over the air. The antenna assembly may, for example, receive RF signals from communications interface 360 and transmit the RF signals over the air, and receive RF signals over the air and provide the RF signals to communications interface 360. In one implementation, for example, communications interface 360 may communicate with network 201.

As will be described in detail below, device 1800 may perform certain operations. Device 1800 may perform these operations in response to processor 320 executing software instructions (e.g., computer program(s)) contained in a computer-readable medium, such as memory 330, a secondary storage device (e.g., hard disk.), or other forms of RAM or ROM. A computer-readable medium may be defined as a non-transitory memory device. A memory device may include space within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

The above-described examples may be implemented in many different forms of software, firmware, and hardware in the implementations illustrated in the figures. In embodiments, the actual software code or specialized control hardware used to implement these aspects should not be construed as limiting. Thus, the operation and behavior of the aspects were described without reference to the specific software code, it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 2, to complete such actions. Also, it will be understood that any of the various actions can result in any type of electronic information to be displayed in real-time and/or simultaneously on multiple devices. For FIG. 10, the order of the blocks may be modified in other implementations. Further, non-dependent blocks may be performed in parallel.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various measurements are provided, such as weight/quantity amounts of materials used in a concrete mix (such as in FIG. 4) that is to be used in a 3D concrete printing device. For each of these measurement quantities, the quantities can range from the specified amount and still be considered to be compliant for the concrete mix described above. For example, for dune sand the quantity can range 50 kg/cubic meters above or below the quantity of 300 kg/cubic meters, and 0-2 mm unwashed sand can range 50 kg/cubic meters above and below 110 kg/cubic meters. Also, for example, the quantity for 0-3 mm sand unwashed can range 50 kg/cubic meters above or below the quantity of 1338.1 kg/cubic meters. Also, for example, the quantity for fly ash can range 20 kg/cubic meters above or below the quantity of 162 kg/cubic meters.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A wax-cellulose nanocomposite material, comprising:
equilibrated amorphous cellulose,
wherein the equilibrated amorphous cellulose has a density of 1.3733 g/cm3;
nonacosane-10-ol;
nonacosane-5,10-diol; and
adulose;

2. The wax-cellulose nanocomposite material of claim 1, wherein the nonacosane-10-ol has a density of 0.840 g/cm3.

3. The wax-cellulose nanocomposite material of claim 1, wherein the adulose has a density of 1.008 g/cm3.

4. The wax-cellulose nanocomposite material of claim 1, wherein the nonacosane-10-ol and the nonacosane-5,10 diol are plant-derived waxes.

5. The wax-cellulose nanocomposite material of claim 1, further comprising:
oxidized Fisher-Tropsh wax.

6. The wax-cellulose nanocomposite material of claim 1, further comprising:
cellulose chains,
wherein the cellulose chains are relaxed and equilibrated for 200 ns; and
two different types of wax,
wherein the two different types of wax are relaxed and equilibrated for 10 ns.

7. The wax-cellulose nanocomposite material of claim 1, wherein the wax-cellulose nanocomposite material is a nano-composite of mixed cellulose chains and waxes.
